(19) United States
(12) Patent Application Publication
(10) Pub. No.: US 2014/0368636 A1
(43) Pub. Date: Dec. 18, 2014

(54) PARKING ASSISTANCE SYSTEM

(71) Applicant: Hyundai Mobis Co., Ltd., Seoul (KR)

(72) Inventor: Seong Soo Lee, Yongin-si (KR)

(73) Assignee: HYUNDAI MOBIS CO., LTD., Seoul (KR)

(21) Appl. No.: 14/256,207

(22) Filed: Apr. 18, 2014

(30) Foreign Application Priority Data
Jun. 12, 2013 (KR) 10-2013-0067081

(51) Int. Cl. G06K 9/00

(52) U.S. Cl. CPC G06K 9/00798
USPC 348/118

(57) ABSTRACT

A parking assistance system may include: an image obtaining unit including a plurality of cameras, and configured to obtain images at front, rear, left, and right sides of the vehicle; an image composing unit configured to compose the image and generate a composed image in a form of an around view; an image processing unit configured to generate a contour line image from the composed image; a parking line recognizer configured to extract parking lines from the contour line image and calculate a parking space through the detected parking lines; and a parking path generating unit configured to generate a parking path or a guide line of the vehicle based on the parking lines or the detected parking space, and provide the parking path or the guide line to a steering wheel controller for automatically controlling a steering wheel or a display unit for displaying the composed image.

### CROSS-REFERENCE TO RELATED APPLICATION

This application claims priority to and the benefit of Korean Patent Application No. 10-2013-0067081 filed in the Korean Intellectual Property Office on Jun. 12, 2013, the entire contents of which are incorporated herein by reference.

### TECHNICAL FIELD

The present invention relates to a parking assistance system, and more particularly, to a parking assistance system mounted in a vehicle to assist steering operation and the like during parking.

### BACKGROUND OF THE INVENTION

In general, when a driver parks a vehicle in a parking space by reversing the vehicle, the driver watches a rearview mirror or turns his/her head toward a rear side and visually checks a rear direction with his/her eyes in order to detect an obstacle at the rear side or a parking position. In order to solve the inconveniences of the reverse parking, a parking assistance apparatus for notifying a driver of existence or not of an obstacle in the rear direction of the vehicle through ultrasonic waves, laser, or the like, or providing a driver with image information of a rear area through a camera mounted at the rear side of the vehicle, and the like has recently been mounted in the vehicle.

Further, recently, there appears a parking assistance apparatus or system for recognizing a parking space, at which parking of a vehicle is available, through an ultrasonic wave sensor, and the like, and allowing the vehicle to be parked through automatic or semiautomatic steering control, thereby improving convenience of a driver. However, the parking assistance apparatus or system in the related art recognizes a parking space based on detection of an obstacle through the ultrasonic wave sensor and the like, so that when another vehicle is not parked in a parking space or another parked vehicle is not correctly parked in accordance with a parking line, there is a technical limit in that it is difficult to accurately recognize the parking space according to the parking line.

### SUMMARY OF THE INVENTION

The present invention has been made in an effort to provide a parking assistance system capable of overcoming a technical limit in recognition of a parking space based on detection of an obstacle through an ultrasonic wave sensor and the like.

An exemplary embodiment of the present invention provides a parking assistance system, including: an image obtaining unit including a plurality of cameras, and configured to obtain images at front, rear, left, and right sides of the vehicle; an image composing unit configured to compose the image and generate a composed image ; an image processing unit configured to generate a contour line image from the composed image; a parking line recognizer configured to extract parking lines from the contour line image and calculate a parking space through the detected parking lines; a parking path generating unit configured to generate a parking path or a guide line of the vehicle based on the parking lines or the parking space, and provide the parking path or the guide line to a steering wheel controller for automatically controlling a steering wheel or to a display unit for displaying the composed image.

The parking assistance system according to the exemplary embodiment of the present invention detects parking lines through image processing, not by an ultrasonic wave sensor and the like, and recognizes a parking space for parking a vehicle through the detected parking lines. Accordingly, even in a case where there is no detectable obstacle and the like adjacent to the parking space, it is possible to recognize a parking space, and perform a function of guiding parking of the vehicle based on the recognized parking space.

### BRIEF DESCRIPTION OF THE DRAWINGS

FIG. 1 is a configuration diagram illustrating a parking assistance system according to an exemplary embodiment of the present invention.

FIGS. 2a, 2b, 2c, and 2d are schematic diagrams illustrating an operation of the parking assistance system according to the exemplary embodiment of the present invention.

FIGS. 3a, 3b, 3c, and 3d are schematic diagrams illustrating a process of detecting a parking line by an image processing unit and a parking line recognizer according to the exemplary embodiment of the present invention.

FIGS. 4a and 4b are schematic diagrams illustrating a process of generating a guide line and a parking path by a parking path generating unit according to the exemplary embodiment of the present invention.

### DETAILED DESCRIPTION OF THE EMBODIMENTS

Hereinafter, exemplary embodiments of the present invention will be described with reference to the accompanying drawings. However, the exemplary embodiments below are provided to help understand the present invention, and the scope of the present invention is not limited to the exemplary embodiments below. Further, the exemplary embodiments below are provided to more fully describe the present invention to those skilled in the art, and detailed explanation of publicly known constitutions which may be determined to unnecessarily obscure the technical point of the present invention may be omitted.

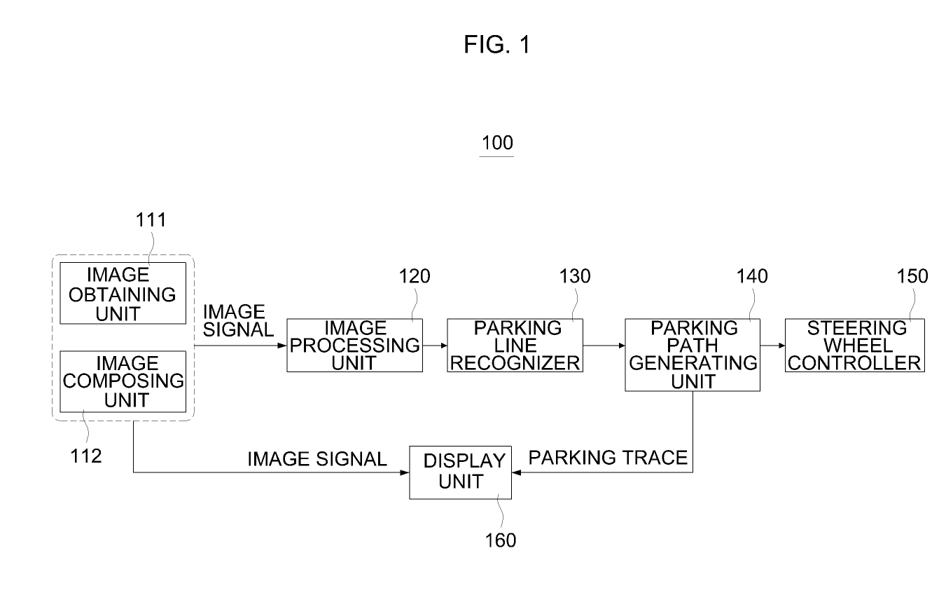

FIG. 1 is a configuration diagram illustrating a parking assistance system according to an exemplary embodiment of the present invention.

Referring to FIG. 1, a parking assistance system 100 according to the present exemplary embodiment includes an image obtaining unit 111 and an image composing unit 112 for providing an image signal, an image processing unit 120 for pre-processing the obtained image, a parking line recognizer 130 for recognizing a parking line and the like from the pre-processed image, a parking path generating unit 140 for generating an optimum parking path of a vehicle, a display unit 160 for displaying an image, a parking path, and the like on screen, and a steering wheel controller 150 for automatically operating a steering wheel of the vehicle according to the generated parking path.

The image obtaining unit 111 includes a plurality of cameras, and obtains images at front and rear, and left and right sides of the vehicle. For example, the image obtaining unit 111 may include a total of four cameras provided at the front, rear, left, and right sides of the vehicle, respectively. The image obtaining unit 111 provides the image composing unit 112 with an image around the vehicle photographed through each camera.

The image composing unit 112 composes the image around the vehicle provided by the image obtaining unit 111, and generates a composed image in a form of a top view or an around view. The composed image in the form of the top view or the around view means an image of the vehicle viewed down from a virtual position at a predetermined height, and the image composing method is publicly known in the art with a name of an around view monitoring (AVM) system, and the like.

In the meantime, the composed image generated by the image obtaining unit 111 and the image composing unit 112 is provided to the display unit 160, and the display unit 160 displays the received composed image on the screen, and provides the driver with virtual visual information about an obstacle and the like around the vehicle. This is similar to a parking assistance system known as the AVM system in the related art.

However, the parking assistance system 100 according to the present exemplary embodiment is different from the AVM system in the related art by including the image processing unit 120 and the parking line recognizer 130, and recognizing a parking line and the like by performing image processing on the composed image. That is, the AVM system in the related art simply composes an image around the vehicle and shows the composed image to the driver, but the parking assistance system 100 according to the present exemplary embodiment detects information necessary for parking, such as a parking line, from the composed image through the image processing.

More particularly, the image processing unit 120 receives an image signal (composed image) from the image obtaining unit 111 and the image composing unit 112, and performs an image processing process for recognizing a parking line. Further, the parking line recognizer 130 receives the image pre-processed by the image processing unit 120 and extracts a parking line candidate point, recognizes an objective parking line through a line fitting algorithm and a geometric condition of the parking line, and detects a parking space, at which parking of the vehicle is available, based on the recognized objective parking line.

The image processing unit 120 and the parking line recognizer 130 recognize the parking line or the parking space based on the image processing, thereby overcoming a technical limit of the parking assistance system in the related art.

For example, the ultrasonic wave sensor, which is currently widely used for recognizing a parking space, recognizes the parking space according to detection of an obstacle, so that when there is no obstacle (that is, another parked vehicle) adjacent to the parking space in which the driver desires to park the vehicle, there incurs a problem in that the ultrasonic wave sensor cannot effectively recognize the parking space. Further, according to the recognition and guidance of the parking space by the ultrasonic wave sensor, the parking is guided in a direction in which the detected obstacle and the vehicle of the driver maintain a predetermined interval, so that when another vehicle adjacent to the parking space is parked but incorrectly parked nearing the parking line, there is also a problem in guiding the driver of the vehicle in that parking is crooked or deviated with respect to the parking line.

However, the parking assistance system 100 according to the present exemplary embodiment directly recognizes the parking line or the parking space through the actually photographed image around the vehicle, not by the detection of the obstacle by the ultrasonic wave sensor, so that even when there is no another vehicle adjacent to the parking space in which the driver desires to park the vehicle, or another surrounding vehicle is parked but incorrectly parked near the parking line, the parking assistance system 100 may recognize an appropriate parking space divided by the parking line.

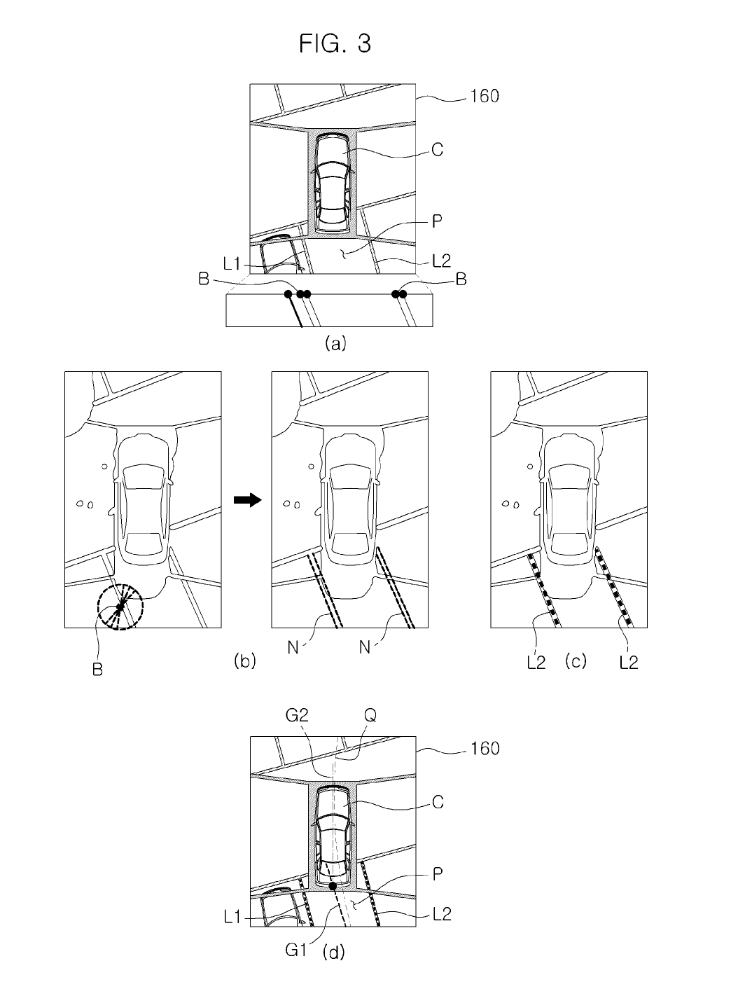

The recognition of the parking line or the parking space through the image processing unit 120 and the parking line recognizer 130 will be additionally described with reference to FIG. 3 to be described below.

In the meantime, the parking path generating unit 140 generates a parking path or a parking trace for parking the vehicle through the parking space recognized by the image processing unit 120 and the parking line recognizer 130. Otherwise, the parking path generating unit 140 may generate a guide line so as to provide the driver with guidance while parking the vehicle within the recognized parking space. Further, the generated parking path, guide line, or the like may be provided to the display unit 160, and may be displayed together with the composed image by the image obtaining unit 111 and the image composing unit 112. For example, the parking path, the guide line, or the like may be displayed in a form overlapping the composed image on the display unit 160, and the parking path or the guide line may be displayed so as to be distinguished by the driver through a figure, a line, color discrimination, shading, and the like on the screen.

Further, as necessary, the parking assistance system 100 according to the present exemplary embodiment may include the steering wheel controller 150, and the steering wheel controller 150 automatically controls a steering wheel through the parking path information provided from the parking path generating unit 140 and makes the vehicle be parked within the parking space. The configuration of generating the parking path and automatically controlling the steering wheel through the generated parking path so that the vehicle may be parked at the recognized parking space or a selected parking position is publicly known in the art with a name of a smart parking assistance system (SPAS).

In the meantime, the display unit 160 may display the composed image provided from the image obtaining unit 111 and the image composing unit 112, the parking trace provided from the parking path generating unit 140, and the like, and notifies the driver of a situation around the vehicle or location information about the driver's own vehicle, and may be formed of a touch screen, a touch panel, or the like so as to receive various directions and options from the driver.

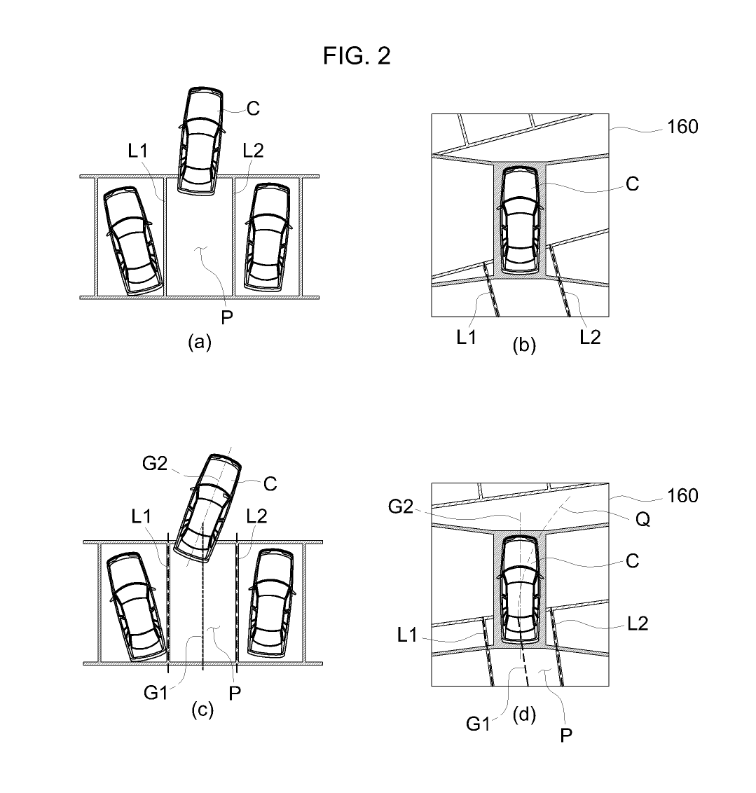

FIG. 2 is a schematic diagram illustrating an operation of the parking assistance system according to the exemplary embodiment of the present invention, as necessary.

Referring to FIG. 2A, first, a driver moves a vehicle C to the vicinity of a parking space P, and operates the parking assistance system 100.

When the parking assistance system 100 is operated, the image obtaining unit 111 obtains an image around the vehicle through the cameras installed at front, rear, left, and right sides of the vehicle, and the image composing unit 112 composes the images and generates the composed image in a form of a top view. The generated composed image is displayed in a form illustrated in FIG. 2B through the display unit 160, and the images at the front, rear, left, and right sides of the vehicle based on the driver's own vehicle C are provided to the driver.

In the meantime, the image processing unit 120 and the parking line recognizer 130 detect both parking lines L1 and L2 defining the parking space P through the composed image, and recognize a space between both detected parking lines L1 and L2 as the parking space P. This will be additionally described with reference to FIG. 3 to be described below.

Next, referring to FIG. 2C, a parking path Q or guide lines G1 and G2 are generated through the parking path generating unit 140. In this case, the parking path generating unit 140 may generate the parking path Q or the guide lines G1 and G2 based on the parking space P recognized by the image processing unit 120 and the parking line recognizer 130. For example, the parking path generating unit 140 may generate the parking path Q so that a center line G1 of both detected parking lines L1 and L2 is matched with a column axis G2 of the vehicle C, or provide the center line G1 and the column axis G2 as the guide lines G1 and G2 for assisting the steering operation of the driver.

Finally, as illustrated in FIG. 2D, the parking path Q or the guide lines G1 and G2 are displayed on the display unit 160 together with the composed image, and the vehicle is completely parked within the parking space P by a steering operation of the driver guided by the guide lines G1 and G2 or automatic steering control by the steering wheel controller 150 and the like.

FIG. 3 is a schematic diagram illustrating a process of detecting a parking line by the image processing unit and the parking line recognizer according to the exemplary embodiment of the present invention.

For reference, a lower end of FIG. 3A, FIG. 3B, and FIG. 3C represent contour line images of the composed image, and light and shade regions are reversed and illustrated for convenience of illustration (that is, lines indicated with a black color in the lower end of FIG. 3A, FIG. 3B, and FIG. 3C are lines indicated to be bright (white) in an actual contour line image, and a background indicated with a white color is a region indicated to be dark (black) in the actual contour line image).

First, referring to FIG. 3A, the image processing unit 120 may generate a contour line image by gray-processing the received composed image, and the parking line recognizer 130 may select points (pixels) having a relatively high brightness change rate in the contour line image as parking line candidate points B.

Further, as illustrated in FIG. 3B, the parking line recognizer 130 extracts a reference line N component for recognizing the parking lines L1 and L2 through a line fitting algorithm of investigating a brightness change rate in a 360° direction based on the selected parking line candidate points B. Otherwise, the parking line recognizer 130 may investigate a 360° direction based on the selected parking line candidate points B, and extract the reference line N component passing through the plurality of candidate points B.

When a plurality of reference lines N is extracted, the parking line recognizer 130 may select an objective reference line N or the objective parking lines L1 and L2 considering position conditions of the actual parking lines L1 and L2. For example, when the vehicle C reverses and is parked in parallel, the parking line recognizer 130 may select the reference line N positioned in a rear direction of the vehicle C and the reference line N disposed to be spaced apart from the reference line N in a direction of a width of the vehicle as the objective reference lines N. This considers the fact that the steering operation or the parking guidance during the reverse parking places focuses on disposing the vehicle between the parking lines L1 and L2 spaced apart from each other in the direction of the width of the vehicle.

In the meantime, when the reference line N component is extracted, final parking lines L1 and L2 are recognized and determined through geometric conditions of the parking lines L1 and L2 as illustrated in FIG. 3C. In this case, thicknesses of the parking lines L1 and L2, an interval between both parking lines L1 and L2, and the like may be considered as the geometric conditions of the parking lines L1 and L2. Further, when the final parking lines L1 and L2 are recognized and determined, a space between the parking lines L1 and L2 may be defined as the parking space P, and a size (that is, a horizontal width) of the parking space P may be calculated through the determined parking lines L1 and L2.

When the parking lines L1 and L2 or the parking space P are recognized through the aforementioned process, the parking path generating unit 140 generates a parking path Q or guide lines G1 and G2 based on the recognized parking lines L1 and L2 or parking space P, and the parking path Q or the guide lines G1 and G2 are displayed on the display unit 160 as illustrated in FIG. 3D, so that the vehicle C is parked by the steering operation of the driver or the steering wheel controller 150.

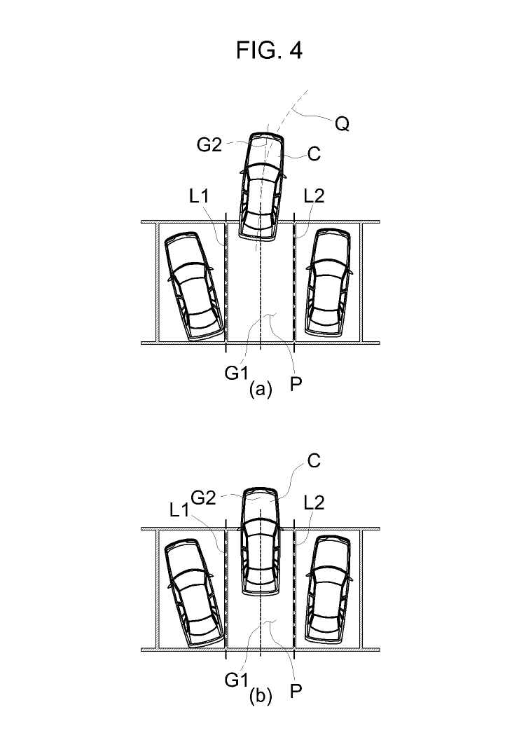

FIG. 4 is a schematic diagram illustrating a process of generating the guide line and the parking path by the parking path generating unit according to the exemplary embodiment of the present invention.

Referring to FIG. 4, the parking path generating unit 140 may set the center line G1 based on both recognized parking lines L1 and L2, and generate the parking path Q so that the column axis G2 of the vehicle C is matched with the center line G1. Further, the center line G1 and the column axis G2 may be displayed on the display unit 160 as a kind of guide lines for the steering operation, and the parking path Q may also be displayed on the display unit 160.

Further, the guide line or the parking path Q displayed on the display unit 160 may be continuously renewed and displayed while moving the vehicle C by the steering operation of the driver or the steering wheel controller 150. Therefore, the driver may more easily and conveniently park the vehicle C within the parking space P while viewing the guide line or the parking path Q, or even in a case where the vehicle is automatically controlled by the steering wheel controller 150, the driver may easily confirm a position or a surrounding situation of the vehicle C.

As described above, the parking assistance system 100 according to the present exemplary embodiment detects the parking lines L1 and L2 through the image processing, not by the ultrasonic wave sensor and the like, and recognizes the parking space P for parking the vehicle through the detected parking lines L1 and L2. Accordingly, even in a case where there is no detectable obstacle and the like adjacent to the parking space P, it is possible to conveniently recognize the parking space P. Further, the parking assistance system 100 according to the present exemplary embodiment sets the center line G1 at the center of both detected parking lines L1 and L2 and generates the parking path Q so that the column axis G2 of the vehicle is matched with the center line G1, or displays the center line G1 and the like on the display unit 160 as the guide line. Accordingly, it is possible to promptly calculate the parking path Q through a simple calculation process, and even though the driver directly performs the steering operation, it is possible to provide easy and intuitive visual information about a parking position of the vehicle.

As described above, the exemplary embodiment of the present invention has been described, but it should be understood that those skilled in the art may modify and change the present invention in various ways without departing from the spirit of the present invention described in the claims by the addition, change, or deletion of constituent elements, and that the modifications and changes are included in the scope of the present invention.

What is claimed is:

1. A parking assistance system, comprising:
an image obtaining unit including a plurality of cameras, and configured to obtain images at front, rear, left, and right sides of the vehicle;
an image composing unit configured to compose the image and generate a composed image in a form of a top view or an around view;
an image processing unit configured to generate a contour line image from the composed image;
a parking line recognizer configured to extract parking lines from the contour line image and detect a parking space through the extracted parking lines; and
a parking path generating unit configured to generate a parking path or a guide line of the vehicle based on the extracted parking lines or the detected parking space.

2. The parking assistance system of claim 1, wherein the parking path generating unit provides the parking path or the guide line to a steering wheel controller for automatically controlling a steering wheel or a display unit for displaying the composed image.

3. The parking assistance system of claim 2, wherein the display unit overlaps the parking path or the guide line and the composed image and displays the parking path or the guide line.

4. The parking assistance system of claim 1, wherein the parking line recognizer selects a pixel having a relatively high brightness change rate in the contour line image as a parking line candidate point.

5. The parking assistance system of claim 4, wherein the parking line recognizer investigates a brightness change rate in a 360° direction based on the selected parking line candidate point and calculates reference line components for extracting the parking lines.

6. The parking assistance system of claim 5, wherein the parking line recognizer selects both reference lines, which are spaced apart from each other in a direction of a width of the vehicle in a rear direction of the vehicle among the calculated reference line components, as objective reference lines.

7. The parking assistance system of claim 6, wherein the parking line recognizer extracts final parking lines by applying geometric conditions of actual parking lines to the selected objective reference lines, and the geometric condition includes at least one of a thickness of the parking line, an interval between both parking lines, and a position of the parking line for the vehicle.

8. The parking assistance system of claim 1, wherein the parking line recognizer detects both parking lines spaced apart from each other in a direction of a width of the vehicle, and
the parking path generating unit sets a center line of both parking lines and a column axis of the vehicle, and generates the parking path so that the center line is matched with the column axis.

9. The parking assistance system of claim 1, wherein the parking line recognizer detects both parking lines spaced apart from each other in a direction of a width of the vehicle, and
the parking path generating unit calculates the center line of both parking lines and the column axis of the vehicle as the guide lines.

10. The parking assistance system of claim 9, wherein the parking path generating unit provides the center line of both parking lines and the column axis of the vehicle to the display unit for displaying the composed image, and
the display unit overlaps the center line of both parking lines and the column axis of the vehicle and the composed image, and displays the center line of both parking lines and the column axis of the vehicle.

11. A parking assistance system, comprising:
an image obtaining unit configured to obtain an image around a vehicle;
an image composing unit configured to compose the image and generate a composed image in a form of a top view or an around view;
an image processing unit configured to generate a contour line image from the composed image;
a parking line recognizer configured to detect both parking lines spaced apart from each other in a direction of a width of the vehicle based on the contour line image;
a parking path generating unit configured to calculate a center line of both parking lines and a column axis of the vehicle as guide lines, and calculate a parking path of the vehicle so that the column axis is matched with the center line; and
a display unit configured to visually display at least one of the guide lines and the parking path on the composed image.

12. The parking assistance system of claim 11, wherein the display unit overlaps at least one of the guide lines and the parking path and the composed image and displays at least one of the guide lines and the parking path.

13. The parking assistance system of claim 11, wherein the parking path generating unit provides the parking path to a steering wheel controller for automatically controlling a steering wheel.

14. The parking assistance system of claim 11, wherein the parking line recognizer selects a pixel having a relatively high brightness change rate in the contour line image as a parking line candidate point, investigates a brightness change rate in a 360° direction based on the parking line candidate point, extracts reference line components, selects both reference lines, which are spaced apart from each other in a direction of a width of the vehicle in a rear direction of the vehicle among the reference line components, as objective reference lines, and detects final parking lines by applying geometric conditions of actual parking lines to the objective reference lines.

15. The parking assistance system of claim 14, wherein the geometric condition includes at least one of a thickness of the parking line, an interval between the parking lines, and a position of the parking line for the vehicle.
